(19) United States
(12) Patent Application Publication
(10) Pub. No.: US 2006/0122889 A1
(43) Pub. Date: Jun. 8, 2006

(54) System and method for managing a plurality of content items displayed in a particular placement position on a rendered page

(75) Inventors: Brian Burdick, Bellevue, WA (US); Christopher A. Meek, Kirkland, WA (US); David E. Heckerman, Bellevue, WA (US); David M. Chickering, Bellevue, WA (US); Joshua J. Forman, Somerville, MA (US); Kevin P. Kornelson, Redmond, WA (US); Murali Vajjiravel, Sammamish, WA (US); Rajeev Prasad, Kirkland, WA (US); Raxit A. Kagalwala, Issaquah, WA (US); Tarek Najm, Kirkland, WA (US); Sachin Dhawan, Redmond, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/994,877

(22) Filed: Nov. 22, 2004

(51) Int. Cl. G06Q 30/00

(52) U.S. Cl. 705/26

(57) ABSTRACT

Systems and method for managing a plurality of content items designated for placement in a particular position on a rendered page are provided. Methods in accordance with the present invention include receiving a plurality of content items, determining an initial placement allocation frequency for each content item, collecting performance data for one or more of the content items, and determining at least one additional allocation frequency in accordance with the performance data collected. Methods of the present invention may further include randomly allocating placement of each of the content items in the particular position on the page in accordance with one of the respective initial and/or additional allocation frequency for each content item. Additionally, the present invention provides systems and methods for automatically managing a plurality of content items to be displayed in a particular position on a rendered page such that value to the content provider may be maximized.

### CROSS-REFERENCE TO RELATED APPLICATIONS

This application is related by subject matter to the invention disclosed in the commonly assigned application U.S. application Ser. No. 10/977,824, filed on Oct. 29, 2004, entitled “Systems and Methods for Determining Bid Value for Content Items to be Placed on a Rendered Page”, which is hereby incorporated herein by reference.

### STATEMENT REGARDING FEDERALLY SPONSORED RESEARCH OR DEVELOPMENT

Not Applicable.

### TECHNICAL FIELD

The present invention relates to computing environments. More particularly, the present invention relates to systems and methods for managing a plurality of content items, e.g., advertisements, images, and/or other creatives, designated by a content provider for placement in a particular position on a rendered page, e.g., a web page. Additionally, the present invention relates to systems and methods for automatically managing a plurality of content items to be displayed in a particular position on a rendered page such that value to the content provider may be maximized.

### BACKGROUND OF THE INVENTION

Searching and choosing products and services through computer-based search engines has become increasingly prolific in recent years. As such, content providers, i.e., those companies and/or individuals desiring content specific to their product(s) and/or service(s) to be displayed on particular web pages, e.g., advertisers, have begun to understand the value that placement of content items (e.g., descriptors or advertisements of their products or services, images, and/or other creatives) on a page rendered according to a given context can have on their sales. However, a content provider often may not know which of a variety of content items will offer the best performance based upon the context of the rendered page and, thus, may wish to have more than one content item designated to a particular placement position so that performance of one content item relative to another may be determined.

In such circumstances, a content provider may place a multiple-creative bid, that is a bid for placement of any of a variety of content items in a particular placement position on a rendered page and subsequently collect data indicative of the performance of the content items relative to one another to determine which content item or items they wish to display more often. However, this process is time-consuming and inefficient for the content provider. Additionally, it can often take a prolonged period of time for such data to be collected and analyzed and, thus, content items offering little value to a content provider may be displayed at a frequency that significantly diminishes the content provider's realized value.

Accordingly, a method for automatically managing a plurality of content items designated by a content provider for placement in a particular position on a rendered page would be desirable. Additionally, a method for managing a plurality of content items such that value to the content provider may be maximized and poorer performing content items may be automatically shown less frequently would be advantageous.

### BRIEF SUMMARY OF THE INVENTION

The present invention relates to systems and methods for managing a plurality of content items designated by a content provider for placement in a particular position on a rendered page, e.g., a web page, such that value to the content provider may be maximized. Accordingly, in one aspect, the present invention is directed to a computer-implemented method for allocating placement of a plurality of content items in a particular position on a page, e.g., a web page, rendered according to a given context. The method includes receiving the content items, determining an initial placement allocation frequency for each of the content items (e.g., advertisements, images, and/or other creatives), and randomly allocating placement of each of the content items in the particular position on the page in accordance with its determined initial placement allocation frequency. The method may further include collecting performance data for one or more of the content items, e.g., determining a click-through-rate (CTR) for one or more of the content items, determining at least one additional placement allocation frequency for the one or more of the content items in accordance with the performance data collected, and randomly allocating placement of the plurality of content items in the particular position on the page in accordance with one of its initial placement allocation frequency and its determined at least one additional placement allocation frequency.

The method may further include determining an initial value for placement of the plurality of content items on the page based upon the initial placement allocation frequency and determining at least one additional value for placement of the content items on the page based upon the at least one additional placement allocation frequency, wherein each additional value is greater than or equal to the initial value, thus maximizing the value to the content provider.

Computer-readable media having computer-executable instructions for performing the methods disclosed herein are also provided.

Additionally, the present invention provides a computer system for managing a plurality of content items (e.g., advertisements, images, and/or other creatives) designated for placement in a particular position on a rendered page, e.g., a web page. Accordingly, in one aspect, the computer system includes a receiving component for receiving the plurality of content items, a first determining component for determining an initial placement allocation frequency for the content items, and a first allocating component for randomly allocating placement of each of the content items in the particular position on the page in accordance with its determined initial placement allocation frequency. The method may further include a performance data collection component for collecting performance data, e.g., CTR, for one or more of the plurality of content items, a second determining component for determining at least one additional placement allocation frequency for one or more of the content items in accordance with the performance data collected, and a second allocating component for randomly allocating placement of the plurality of content items in the particular position on the page in accordance with one of its initial placement allocation frequency and its determined at least one additional placement allocation frequency.

The method may further include an initial value determining component for determining a first value for placement of the plurality of content items on the page based upon the respective initial placement allocation frequency of each content item and an additional value determining component for determining at least one additional value for placement of the content items on the page based upon one of the initial allocation frequency and the at least one additional allocation frequency of each content item, wherein each additional value is greater than or equal to the initial value, thus maximizing value to the content provider.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention; and

FIG. 2 is a flow diagram showing a computer-implemented method for managing a plurality of content items to be displayed in a particular placement position on a rendered page, e.g., a web page, in accordance with an embodiment of the present invention.

### DETAILED DESCRIPTION OF THE INVENTION

The present invention provides systems and methods for managing a plurality of content items, e.g., advertisements, images, and/or other creatives, designated by a content provider for placement in a particular position on a rendered page, e.g., a web page. Additionally, the present invention relates to systems and methods for automatically managing a plurality of content items to be displayed in a particular position on a rendered page such that value to the content provider may be maximized and better performing content items are automatically displayed more frequently than poorer performing content items.

Having briefly described an overview of the present invention, an exemplary operating environment for the present invention is described below.

Exemplary Operating Environment

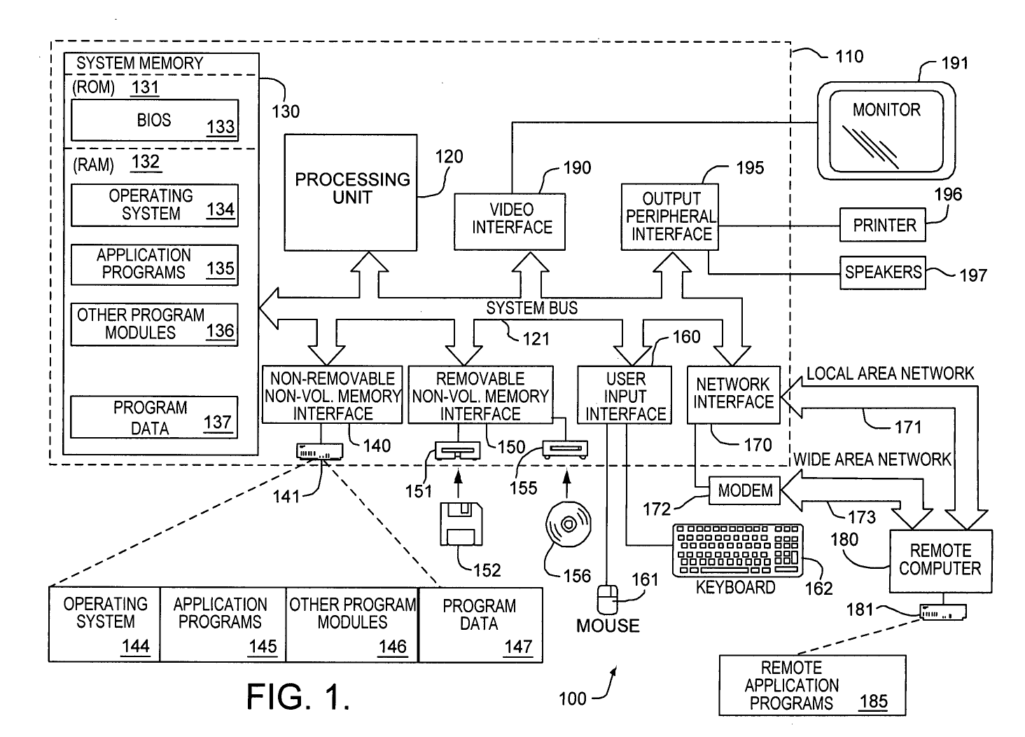

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between the various steps herein disclosed unless and except when the order of individual steps is explicitly described.

As previously mentioned, the present invention relates to systems and methods for managing a plurality of content items designated by a content provider for placement in a particular position on a rendered page, e.g., a web page, such that value to the content provider may be maximized. Accordingly, in one embodiment of the present invention, a content provider (e.g., an advertiser) may be permitted to designate more than one content item (e.g., an advertisement, image, and/or other creative) for placement in a particular placement position on a rendered page. Subsequently, each of the content items designated for the particular placement position will be displayed in the particular position at a frequency proportional to the performance of that content item relative to the performance of the other content items designated for the same placement position, as more fully described below.

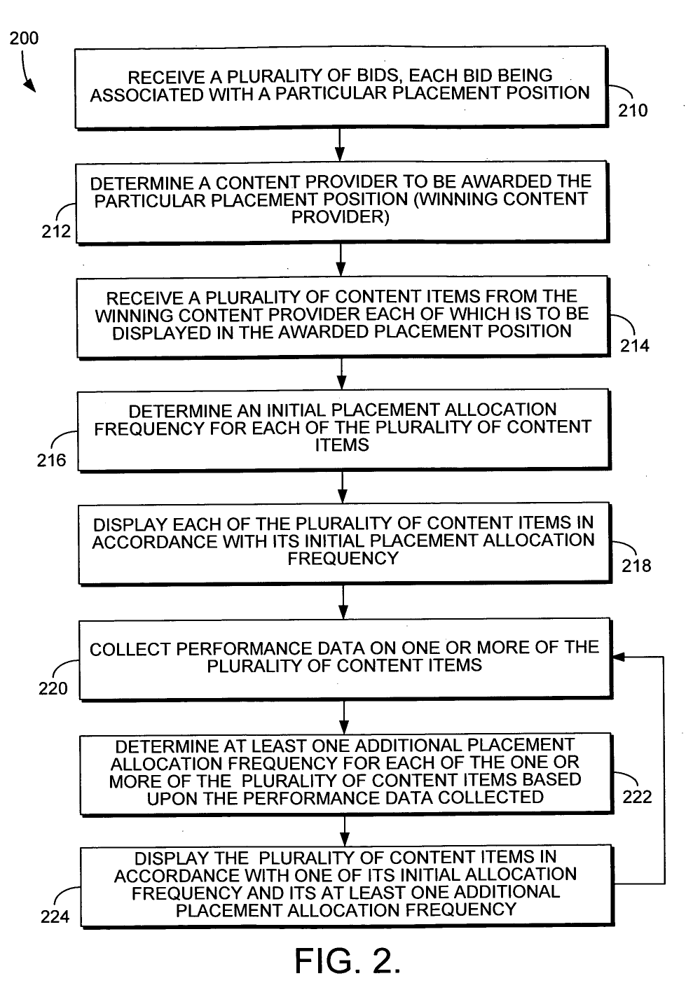

With reference to FIG. 2, a flow diagram is illustrated which shows a computer-implemented method 200 for managing a plurality of content items to be displayed in a particular placement position on a rendered page, e.g., a web page, in accordance with an embodiment of the present invention. Initially, as shown at block 210, the system receives a plurality of multiple-creative bids (that is, bids associated with multiple creatives to be displayed), each bid being associated with a particular placement position on a rendered page. By way of example and not limitation, a plurality of content providers may each bid for placement of one or more of their content items in the position of a banner advertisement on a particular rendered page, e.g., a web page.

Subsequently, as shown at block 212, the system determines which content provider placed the winning bid for the particular placement position, i.e., the “winning” content provider, and awards that content provider the particular placement position. The winning content provider may be determined by any number of criteria including, by way of example only, determining which content provider placed the highest bid for each time any of its content items are displayed on the page, that is, the highest cost-per-impression (CPI) bid. A number of other criteria for determining which content provider is the winning content provider are disclosed in commonly assigned application U.S. application Ser. No. 10/977,824, filed on Oct. 29, 2004, entitled “Systems and Methods for Determining Bid Value for Content Items to be Placed on a Rendered Page”, which was hereinabove incorporated by reference herein.

Subsequently, as shown at block 214, the system receives a plurality of content items, each of which the winning content provider desires to have placed in the particular placement position at a dynamically varying frequency, as more fully described below.

Next, as shown at block 216, an initial placement allocation frequency is determined for each of the plurality of content items, the initial placement allocation frequency for each of the plurality of content items being greater than zero. In one embodiment, the allocation frequency for each content item may be initially determined based upon a performance history of the content provider and/or the content items being placed. That is, a content item having a performance history which is indicative of, for instance, a high click-through-rate relative to the other content items received for placement, may be determined to have an initial placement allocation frequency that is greater than the other designated content items.

Alternatively, the allocation for each content item may be initially determined equivalently until performance of the content items with respect to one another may be determined, as more fully described below. By way of example only, contemplate a scenario wherein a content provider has four advertisements that it desires to rotate through placement in the position of a banner advertisement on a particular web page—Advertisement A, Advertisement B, Advertisement C, and Advertisement D. Each of the four advertisements may be related to the same product and/or service or different products and/or services, if desired. In accordance with this embodiment of the present invention, the initial frequency for each of the four advertisements may be equivalently allocated at 25%.

It will be understood and appreciated by those of ordinary skill in the art that initial allocation frequencies may be determined by any of a variety of methods, including either of the above-described methods (or any combination thereof), and that all such alternatives are contemplated to be within the scope of the present invention.

One way in which the allocation methodology of the present invention may be thought of is to contemplate that lottery tickets are awarded to each of the content items, the number of lottery tickets awarded being initially determined based upon the respective initial placement allocation frequencies, and a simulated random lottery drawing is performed to choose which content item is designated for placement in the particular placement position each time a content item is to be displayed to a user. In the above-described scenario, the number of lottery tickets awarded each content item based upon an equivalent initial placement allocation frequency for each would also be equivalent, as shown in Table I. Table I contemplates that a total of 65,000 lottery tickets are awarded.

TABLE I

| | Initial Placement | Number of |
|---|---|---|
| Content Item | Allocation Frequency | Lottery Tickets |
| A | 0.25 | 16,250 |
| B | 0.25 | 16,250 |
| C | 0.25 | 16,250 |
| D | 0.25 | 16,250 |

In this example, each content item has been allocated a number of tickets proportional to its value relative to the whole. When a winning ticket is chosen randomly, each content item will have an equivalent chance of being selected. Thus, each content item that was designated for placement in the particular position may be subsequently randomly displayed in that position in accordance with its initial placement allocation frequency, as shown at block 218. Accordingly, in the above-described scenario, each of Advertisements A, B, C, and D may be randomly displayed in the banner advertisement position of the web page 25% of the time.

It will be understood and appreciated by those of ordinary skill in the art that the present invention is not intended to be limited to the above-described initial allocation methods. Rather, any number of initial placement allocation determinations may be made, each of which is contemplated to be within the scope of the present invention. For instance, the content provider may designate the initial placement allocation frequencies that it desires.

Next, as shown at block 220, the system may collect performance data on one or more of the plurality of content items displayed in the particular position. Performance data may be collected based upon a variety of criteria one of which may be, by way of example only, click-through-rate (CTR). Thus, the performance of one or more of the content items displayed in the particular position may be collected based upon the rate at which users select the content item when it is displayed and, accordingly, access additional information associated therewith. It will be understood by those of ordinary skill in the art, however, that performance may be collected other than on the basis of CTR, for instance, it may be collected on the basis of sales completed as a result of the content item being displayed or the like, and, accordingly, the criteria for collection of performance data is not intended to limit the scope of the present invention in any way.

Subsequently, as shown at block 222, at least one additional placement allocation frequency is determined for each of the one or more of the plurality of content items based upon the performance data collected. That is, if performance data was collected on the basis of CTR, at least one additional placement allocation frequency may be determined for one or more of the plurality of content items displayed based upon the rate at which users selected the content item when it was displayed and, accordingly, accessed additional information associated therewith.

In accordance with the present invention, the at least one additional placement allocation frequency is determined based upon the performance of each content item relative to the performance of all content items designated for placement in the same placement position. That is, the at least one additional placement allocation frequency may be determined according to following formula:

Additional placement allocation frequency of content item X=(Performance of content item X)/sum (performance of all content items designated for placement).

Thus, if CTR is the performance criteria upon which allocation frequencies are to be determined, the at least one additional placement allocation frequency for content item X may be determined as:

$$Performance ( X ) = \frac{CTR ( X )}{\sum CTR ( i )}$$

wherein i represents all content items designated for placement in the particular position on the web page. Note that if no performance data was collected for a particular content item, its CTR may be equal to zero.

With reference back to the lottery ticket analogy hereinabove described, contemplate that performance data was collected for each of the advertisements on the basis of CTR and that the CTR of Advertisement A was 0.1, the CTR of Advertisement B was 0.2, the CTR of Advertisement C was 0.3 and the CTR of Advertisement D was 0.4. The additional placement allocation frequency and corresponding number of lottery tickets awarded each content item (based on a total of 65,000 tickets) would be as shown in Table II.

TABLE II

| | Additional Placement | Number of |
|---|---|---|
| Content Item | Allocation Frequency | Lottery Tickets |
| A | 0.1/(0.1 + 0.2 + 0.3 + 0.4) = 0.10 | 6,500 |
| B | 0.2/(0.1 + 0.2 + 0.3 + 0.4) = 0.20 | 13,000 |
| C | 0.3/(0.1 + 0.2 + 0.3 + 0.4) = 0.30 | 19,500 |
| D | 0.4/(0.1 + 0.2 + 0.3 + 0.4) = 0.40 | 26,000 |

In this example, each content item has been allocated a number of tickets proportional to its value relative to the whole. Thus, each content item that was designated for placement in the particular position may be randomly displayed in that position in accordance with one or its initial allocation frequency and its additional placement allocation frequency, as shown at block 224. Accordingly, in the above-described scenario, Advertisement A may be randomly displayed in the banner advertisement position of the web page 10% of the time, Advertisement B may be randomly displayed 20% of the time, Advertisement C may be randomly displayed 30% of the time and Advertisement D may be randomly displayed 40% of the time.

As can be understood, the present invention provides systems and methods for automatically managing a plurality of content items to be displayed in a particular position on rendered page such that value to the content provider may be maximized. Thus, in a currently preferred embodiment, the method of the present invention further includes determining an initial value for placement of the plurality of content items on the page based upon the initial placement allocation frequency (that is, the total value to the content provider for placement of the designated content items in accordance with the respective initial placement allocation frequency for each of the content items) and determining at least one additional value for placement of the plurality of content items on the page based upon the at least one additional placement allocation frequency of the one or more the plurality of content items (that is, the total value to the content provider for placement of the designated content items in accordance with one of its initial placement allocation frequency and its at least one additional placement allocation frequency for each of the content items), wherein each additional value is greater than or equal to the initial value. In this way, value to the content provider may be maximized.

Additionally, in a currently preferred embodiment, additional placement allocation frequencies may be determined for one or more of the plurality of content items dynamically in near real-time such that the allocation frequencies are recurrently determined over the course of a given time frame. This dynamic allocation is automatically performed by the system without user intervention such that value to the content provider is continuously automatically maximized and better performing content items are automatically displayed more frequently than poorer performing content items. Thus, as shown in FIG. 2, once the plurality of content items is displayed based on one of their initial or additional allocation frequency, the method of the present invention may return to block 220 wherein performance data may again be collected for one or more of the displayed content items.

In one embodiment of the present invention, one or both of the initial and additional placement allocation frequencies may be determined in a manner that is tailored to the user viewing the displayed content item. In this embodiment, the method further comprises receiving at least one user-specific data item, e.g., the user's demographic location, and tailoring one or both of the initial and additional placement allocation frequencies accordingly. For instance, returning to the above-described scenario, if it is known that a user in Chicago is twice as likely to respond to Advertisement A than to any of Advertisements B, C or D, a respective initial placement allocation frequency for a Chicago user may be 40% for Advertisement A and 20% for each of Advertisements B, C, and D. Similarly, if it is determined through performance data collection that a user from Los Angeles is four times as likely to respond to either Advertisement A or Advertisement B than to either of Advertisements C or D, the respective additional placement allocation frequency for a Los Angeles user may be 40% for Advertisements A and B and 10% for Advertisements C and D.

It will be understood and appreciated by those of ordinary skill in the art that a variety of user-specific data items other than demographics may be used to tailor the initial and/or additional placement allocation frequencies. By way of example only, the gender of the user or time of day the content item is being displayed may affect the behavior of the user with respect to the content item. Thus, all variations wherein data items specific to one or more users are known and may be utilized to tailor the initial and/or additional placement allocation frequencies are contemplated to be within the scope of the present invention.

In summary, the present invention provides systems and methods for managing a plurality of content items, e.g., advertisements, images, and/or other creatives, designated by a content provider for placement in a particular position on a rendered page, e.g., a web page. Additionally, the present invention provides systems and methods for automatically managing a plurality of content items to be displayed in a particular position on a rendered page such that value to the content provider may be maximized and better performing content items may be automatically displayed more frequently than poorer performing content items. Using the lottery-like analogy described hereinabove, content items will not be eliminated from display until their performance relative to the other content items designated for placement in the same position falls below one divided by the total number of total lottery tickets awarded. Additionally, content items that may have poor performance initially will automatically be displayed more often if their performance improves.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A computer-implemented method for managing a plurality of content items to be displayed in a particular position on a page rendered according to a given context, comprising:
receiving the plurality of content items;
determining an initial placement allocation frequency for each of the plurality of content items; and
randomly allocating placement of each of the plurality of content items in the particular position on the page in accordance with its determined initial placement allocation frequency.

2. The computer-implemented method of claim 1, wherein determining the initial placement allocation frequency for each of the plurality of content items comprises determining an equivalent initial placement allocation frequency for each of the plurality of content items.

3. The computer-implemented method of claim 1, wherein randomly allocating placement of each of the plurality of content items in the particular position on the page comprises randomly displaying each of the plurality of content items in the particular position on the page in accordance with its determined initial placement allocation frequency.

4. The computer-implemented method of claim 1, further comprising collecting performance data for one or more of the plurality of content items.

5. The computer-implemented method of claim 4, further comprising determining at least one additional placement allocation frequency for the one or more of the plurality of content items in accordance with the performance data collected.

6. The computer-implemented method of claim 5, wherein collecting performance data for the one or more of the plurality of content items comprises determining a click-through-rate for the one or more of the plurality of content items.

7. The computer-implemented method of claim 6, wherein determining the at least one additional placement allocation frequency for the one or more of the plurality of content items comprises dividing the click-through-rate for each of the one or more of the plurality of content items by a sum of the click-through-rates for all of the plurality of content items for which click-through rate was determined.

8. The computer-implemented method of claim 5, further comprising randomly allocating placement of the plurality of content items in the particular position on the page in accordance with one of its initial placement allocation frequency and its determined additional placement allocation frequency.

9. The computer-implemented method of claim 8, wherein randomly allocating placement of the plurality of content items in the particular position on the page comprises randomly displaying the plurality of content items in the particular position on the page in accordance with one of its initial placement allocation frequency and its determined additional placement allocation frequency.

10. The computer-implemented method of claim 5, further comprising:
determining an initial value for placement of the plurality of content items on the page based upon the initial placement allocation frequency for each of the plurality of content items; and
determining at least one additional value for placement of the plurality of content items on the page based upon the additional placement allocation frequency for the one or more of the plurality of content items,
wherein each additional value is greater than or equal to the initial value.

11. The computer-implemented method of claim 5, wherein determining the at least one additional placement allocation frequency for the one or more of the plurality of content items comprises determining the at least one additional placement allocation frequency dynamically.

12. The computer-implemented method of claim 1, further comprising receiving at least one user-specific data item.

13. The computer-implemented method of claim 12, wherein determining the initial placement allocation frequency for each of the plurality of content items comprises determining the initial placement allocation frequency for each of the plurality of content items in accordance with the at least one user-specific data item.

14. The computer-implemented method of claim 12, wherein receiving at least one user-specific data item comprises receiving at least one user-specific demographic data item.

15. The computer-implemented method of claim 5, further comprising receiving at least one user-specific data item.

16. The computer-implemented method of claim 15, wherein determining the at least one additional placement allocation frequency for the one or more of the plurality of content items comprises determining the at least one additional placement allocation frequency for the at least one of the plurality of content items in accordance with the at least one user-specific data item.

17. The computer-implemented method of claim 1, wherein each of the plurality of content items is associated with an identical or related product or service.

18. A computer programmed to perform the steps recited in the computer-implemented method of claim 1.

19. A computer-readable medium having computer-executable instructions embodied thereon for managing a plurality of content items to be displayed in a particular position on a page rendered according to a given context, comprising:
code for receiving the plurality of content items;
code for determining an initial placement allocation frequency for each of the plurality of content items; and
code for randomly allocating placement of each of the plurality of content items in the particular position on the page in accordance with its determined initial placement allocation frequency.

20. The computer-readable medium of claim 19, wherein the code for determining the initial placement allocation frequency for each of the plurality of content items includes code for determining an equivalent initial placement allocation frequency for each of the plurality of content items.

21. The computer-readable medium of claim 19, wherein the code for randomly allocating placement of each of the plurality of content items in the particular position on the page includes code for randomly displaying each of the plurality of content items in the particular position on the page in accordance with its determined initial placement allocation frequency.

22. The computer-readable medium of claim 19, further comprising code for collecting performance data for one or more of the plurality of content items.

23. The computer-readable medium of claim 22, further comprising code for determining at least one additional placement allocation frequency for the one or more of the plurality of content items in accordance with the performance data collected.

24. The computer-readable medium of claim 23, wherein the code for collecting performance data for the one or more of the plurality of content items includes code for determining a click-through-rate for the one or more of the plurality of content items.

25. The computer-readable medium of claim 24, wherein the code for determining the at least one additional placement allocation frequency for the one or more of the plurality of content items includes code for dividing the click-through-rate for each of the one or more of the plurality of content items by a sum of the click-through-rates for all of the plurality of content items for which click-through-rate was determined.

26. The computer-readable medium of claim 23, further comprising code for randomly allocating placement of the plurality of content items in the particular position on the page in accordance with one of its initial placement allocation frequency and its determined additional placement allocation frequency.

27. The computer-readable medium of claim 26, wherein the code for randomly allocating placement of the plurality of content items in the particular position on the page includes code for randomly displaying the plurality of content items in the particular position on the page in accordance with one of its initial placement allocation frequency and its determined additional placement allocation frequency.

28. The computer-readable medium of claim 23, further comprising:
code for determining an initial value for placement of the plurality of content items on the page based upon the initial placement allocation frequency for each of the plurality of content items; and
code for determining at least one additional value for placement of the plurality of content items on the page based upon the additional placement allocation frequency for each of the plurality of content items,
wherein each additional value is greater than or equal to the initial value.

29. The computer-readable medium of claim 23, wherein the code for determining the at least one additional placement allocation frequency for the one or more of the plurality of content items includes code for determining the at least one additional placement allocation frequency dynamically.

30. A computer system for managing a plurality of content items to be displayed in a particular position on a page rendered according to a given context, comprising:
a receiving component for receiving the plurality of content items;
a first determining component for determining an initial placement allocation frequency for each of the plurality of content items; and
a first allocating component for randomly allocating placement of each of the plurality of content items in the particular position on the page in accordance with its determined initial placement allocation frequency.

31. The computer system of claim 30, wherein the determining component is capable of determining an equivalent initial placement allocation frequency for each of the plurality of content items.

32. The computer system of claim 30, wherein the first allocating component is capable of randomly displaying each of the plurality of content items in the particular position on the page in accordance with its determined initial placement allocation frequency.

33. The computer system of claim 30, further comprising a performance data collection component for collecting performance data for each one or more plurality of content items.

34. The computer system of claim 33, further comprising a second determining component for determining at least one additional placement allocation frequency for the one or more of the plurality of content items in accordance with the performance data collected.

35. The computer system of claim 34, wherein the collection component is capable of determining a click-through-rate for the one or more of the plurality of content items.

36. The computer system of claim 35, wherein the second determining module is capable of dividing the click-through-rate for each of the one or more of the plurality of content items by a sum of the click-through-rates for all of the plurality of content items for which click-through-rate was determined.

37. The computer system of claim 34, further comprising a second allocation component for randomly allocating placement of the plurality of content items in the particular position on the page in accordance with one of its initial placement allocation frequency and its determined additional placement allocation frequency.

38. The computer system of claim 34, further comprising:
an initial value determining component for determining an initial value for placement of the plurality of content items on the page based upon the initial placement allocation frequency for each of the plurality of content items; and
an additional value determining component for determining at least one additional value for placement of the plurality of content items on the page based upon the additional placement allocation frequency for the one or more of the plurality of content items,
wherein each at least one additional value is greater than or equal to the initial value.

39. The computer system of claim 34, wherein the second determining component is capable of determining the at least one additional placement allocation frequency dynamically.
